(19) United States
(12) Patent Application Publication
(10) Pub. No.: US 2011/0310158 A1
(43) Pub. Date: Dec. 22, 2011

(54) INKJET IMAGE FORMING APPARATUS AND INKJET IMAGE FORMING METHOD

(75) Inventors: Kazunori Hirabayashi, Kanagawa-ken (JP); Takahiro Hagiwara, Chiba-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/164,068

(22) Filed: Jun. 20, 2011

Related U.S. Application Data
(60) Provisional application No. 61/356,898, filed on Jun. 21, 2010.

(51) Int. Cl. B41J 29/38

(52) U.S. Cl. 347/16

(57) ABSTRACT

According to one embodiment, an image forming apparatus includes an endless device, an inkjet head, a dryer, a sensor, and a controller. The endless device rotates at fixed circumferential speed. The inkjet head prints on a recording medium held by the endless device and rotating together with the endless device. The dryer dries the recording medium rotating together with the endless device. The sensor is provided to be opposed to the endless device and detects a surface state of the recording medium printed upon by the inkjet head. The controller determines a dried state of the recording medium on the basis of the surface state detected by the sensor and switches, according to a determination result, control of the next process to drying and paper discharge in a unit of one rotation of the endless device.

### CROSS-REFERENCE TO RELATED APPLICATION

This application is based upon and claims the benefit of U.S. Provisional Application No. 61/356,898, filed Jun. 21, 2010; the entire contents of which are incorporated herein by reference.

### FIELD

Embodiments described herein relate generally to an inkjet image forming apparatus and an inkjet image forming method.

### BACKGROUND

An inkjet image forming apparatus of a multipath system (hereinafter referred to as image forming apparatus) is known. The image forming apparatus ejects inks from linearly arranged heads (hereinafter referred to as line heads) on a recording medium such as a sheet attracted on a drum or a belt and performs image recording plural times (in multipath). In each of processes of the multipath, the positions of the line heads move in a unit of several pixels and an image is formed. Even if the resolution of an image formed by driving the line heads once is rough, an image having high resolution can be generated by driving the line heads plural times according to the multipath system.

If the inks are deposited on the sheet in the multipath system plural times to form a high-resolution image, an amount of inks used for the formation of the image increases. Therefore, if the sheet is discharged while the inks adhering to the sheet are not sufficiently dried, colors could be transferred to other printed sheets.

### BRIEF DESCRIPTION OF THE DRAWINGS

FIG. 1 is a diagram of an exemplary schematic configuration of a print engine of an inkjet image forming apparatus according to an embodiment;

FIG. 2 is a diagram of an exemplary schematic configuration of line heads for respective colors of the inkjet image forming apparatus according to the embodiment;

FIG. 3 is a diagram of an exemplary schematic configuration of a control system of the inkjet image forming apparatus according to the embodiment;

FIG. 4 is an exemplary flowchart for explaining an image forming operation procedure of the inkjet image forming apparatus according to the embodiment;

FIG. 5 is an exemplary diagram of a region used for dryness determination according to the embodiment;

FIG. 6 is an exemplary graph for explaining a method of predicting a dried state according to the embodiment;

FIG. 7 is an exemplary flowchart for explaining an image forming operation procedure of an inkjet image forming apparatus according to a second embodiment; and

FIG. 8 is an exemplary flowchart for explaining an image forming operation procedure of an inkjet image forming apparatus according to a third embodiment.

### DETAILED DESCRIPTION

In general, according to one embodiment, an image forming apparatus includes an endless device, an inkjet head, a dryer, a sensor, and a controller. The endless device rotates at fixed circumferential speed. The inkjet head prints on a recording medium held by the endless device and rotating together with the endless device. The dryer dries the recording medium rotating together with the endless device. The sensor is provided to be opposed to the endless device and detects a surface state of the recording medium printed by the inkjet head. The controller determines a dried state of the recording medium on the basis of the surface state detected by the sensor and switches, according to a determination result, control of the next process to drying and paper discharge in a unit of one rotation of the endless device.

### First Embodiment

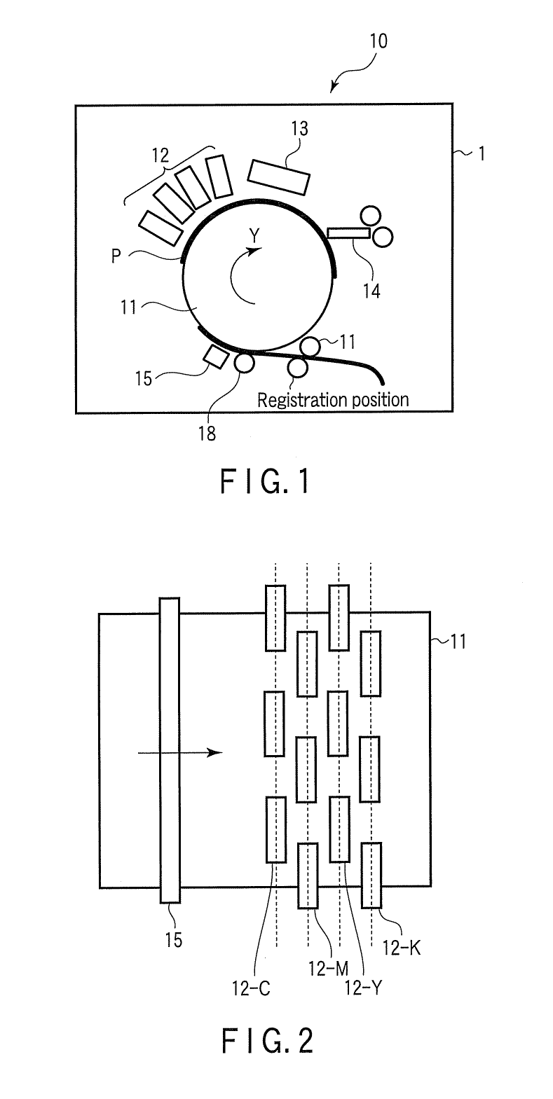

FIG. 1 is a diagram of an exemplary schematic configuration of a print engine 10 of an inkjet image forming apparatus 1 according to a first embodiment.

The print engine 10 includes a drum 11, which is an endless device, a line head unit 12, a drying unit 13, a paper discharge unit 14, an image sensor 15, and a conveying unit 17.

The drum 11 can rotate at predetermined circumferential speed. The drum 11 can attract and hold a sheet P on the outer circumferential surface of the drum 11. The line head unit 12 includes line heads 12-C, 12-M, 12-Y, and 12-K for respective colors of C (Cyan), M (Magenta), Y (Yellow), and K (key color: Black). The line heads 12-C, 12-M, 12-Y, and 12-K are provided in a direction (a main scanning direction) orthogonal to a rotating direction Y of the drum 11 and can perform printing in the main scanning direction at a time.

The drying unit 13 blows air or heated air against the sheet P to dry inks. The paper discharge unit 14 discharges the sheet P, on which an image is formed and the inks are dried, to the outside of a system. A light receiving surface of the image sensor 15 is arranged in a position opposed to the drum 11 and detects, for example, the position and the tilt of the sheet P on the drum 11 and a dried state of the inks on the sheet P. The conveying unit 17 feeds the sheet P, which is picked up from a sheet cassette (not shown), to the drum 11 in synchronization with image formation timing. A charging roller 18 attracts a sheet to the drum 11 through electrostatic attraction (an electrostatic attraction system). Besides the electrostatic attraction system, a suction attraction system for attracting a sheet to the drum 11 through air attraction by suction of a fan may be adopted. In the suction attraction system, plural holes are opened on the outer circumferential surface of the drum 11.

The operation of the print engine 10 is explained below.

The conveying unit 17 picks up the sheet P from the sheet cassette (not shown), conveys the sheet P to a registration position, and puts the sheet P on standby. The print engine 10 waits for image data to be ready for printing and feeds the sheet P registered immediately before the drum 11 to the drum 11 in synchronization with image formation timing.

When the sheet P is fed to the drum 11, the sheet P could be attracted while being tilted. If the line heads 12-C, 12-M, 12-Y, and 12-K eject inks and perform printing while the sheet P is left tilted, the inks are deposited in a place other than the sheet P, i.e., on the drum 11 and cause stains in the following printing.

Therefore, the position and the tilt of sheet are detected using the image sensor 15. According to a detection result, image data to be printed is generated such that a printed region is a region within the sheet P. Further, the image sensor 15 detects a dried state of the sheet P. Details of a method of detecting a dried state are explained later.

As the image sensor 15, for example, a contact image sensor (CIS) can be used. The CIS is a sensor configured integrally with an LED (Light Emitting Device). The CIS reads reflected light of the LED and detects a state of the sheet P. The image sensor 15 can be configured as an inexpensive, space-saving, and power-saving sensor by using the CIS. The image sensor 15 is not limited to the CIS and may be configured using a line sensor or an area sensor.

The sheet P is rotated and conveyed by the drum 11. The inks are sprayed on the sheet P by the line heads 12-C, 12-M, 12-Y, and 12-K for the respective colors. FIG. 2 is a diagram of an exemplary schematic configuration of the line heads for the respective colors of the inkjet image forming apparatus 1 according to this embodiment. In the configuration shown in FIG. 2, the line heads for the respective colors are configured to be movable in a main scanning direction in the figure.

The sheet P is rotated and conveyed by the drum 11. The inks on the sheet P are dried by the drying unit 13. The drying unit 13 blows air or heated air against the sheet P and dies the inks. Until a path is executed a predetermined number of times, the sheet P is conveyed to the position of the image sensor 15 again without being discharged to the outside of the system. It is detected according to data detected by the image sensor 15, whether the inks on the sheet P are dried. In order to form a high-resolution image, printing processing by the line heads and drying processing by the drying unit 13 are repeatedly executed on the sheet P. When the image formation and the drying of a formed image are completed, the paper discharge unit 14 discharges the sheet P to the outside of the system.

The print engine 10 is controlled by a processor 22a for print engine control explained later.

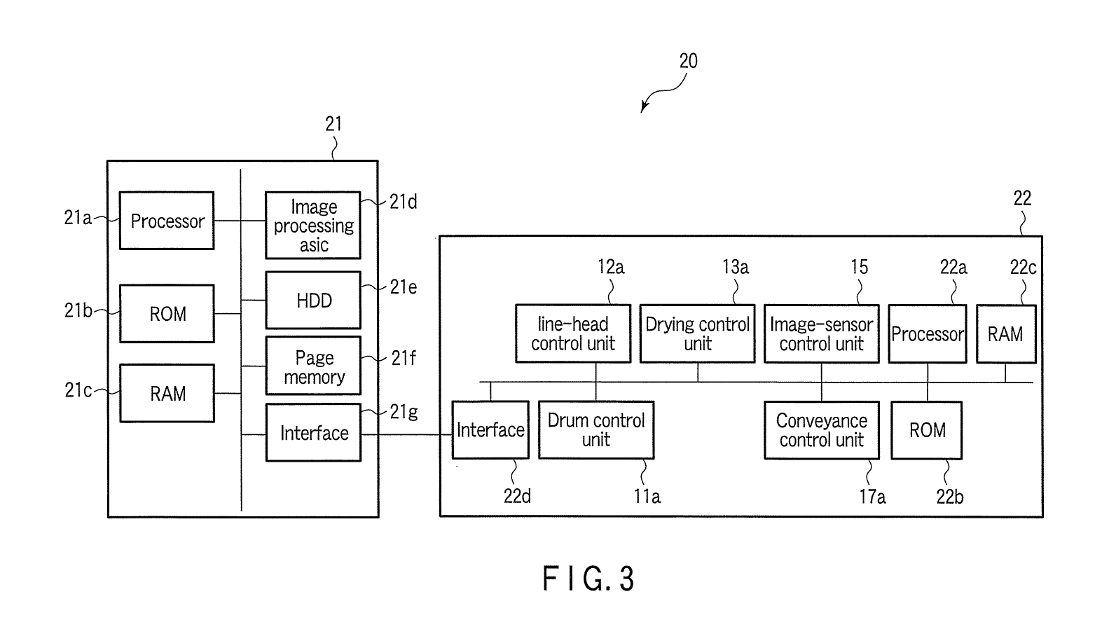

FIG. 3 is a diagram of an exemplary schematic configuration of a control system 20 of the inkjet image forming apparatus 1 according to this embodiment. The control system 20 of the inkjet image forming apparatus 1 includes a system control section 21 and an engine control section 22.

The system control section 21 includes a processor 21a, a ROM 21b, a RAM 21c, an image processing ASIC 21d, a HDD 21e, a page memory 21f, and an interface 21g. The processor 21a collectively controls the operation of the system control section 21.

The engine control section 22 includes a processor 22a, a ROM 22b, a RAM 22c, an interface 22d, a drum control unit 11a, a line-head control unit 12a, a drying control unit 13a, an image-sensor control unit 15a, and a conveyance control unit 17a. The processor 22a collectively controls the operation of the engine control section 22.

In the system control section 21, the processor 21a receives PDL (Page Description Language) data indicating the structure of image data from an external information processing apparatus (not shown) and stores the PDL data in the HDD (Hard Disc Drive) 21e, which is an internal memory. When printing is executed, the processor 21a performs RIP processing (Raster Image Processing) and converts the PDL data into bitmap data. The bitmap data is transferred to the image processing ASIC 21d and subjected to image compression. The compressed data is stored in the HDD 21e and subjected to electronic sort.

The data subjected to the image compression is loaded from the HDD 21e. The image processing ASIC 21d executes expansion processing and image quality adjustment processing. The processed data is arranged on the page memory 21f and then transferred to the engine control section 22 via the interface 21g.

The engine control section 22 receives, via the interface 22d, the data transmitted from the system control section 21. The engine control section 22 converts the received bitmap image data into a driving signal. The engine control section 22 performs conveyance of the sheet P, driving control for the line head unit 12, and the like to perform a printing operation.

The conveyance control unit 17a controls a conveying operation for the sheet P. The drum control unit 11a drives a drum motor (not shown) to control the rotation of the drum 11. In the electrostatic attraction system, the conveyance control unit 17a controls the charging roller 18 as well. In the case of suction attraction, the conveyance control unit 17a controls the fan as well. The image-sensor control unit 15a acquires a detection signal of the image sensor 15 and outputs the detection signal to the processor 22a. The line-head control unit 12a drives the line heads for the respective colors. The drying control unit 13a controls the operation of the drying unit 13. The ROM 22b has stored therein a computer program for controlling the print engine 10. The RAM 22c stores data for controlling the print engine 10.

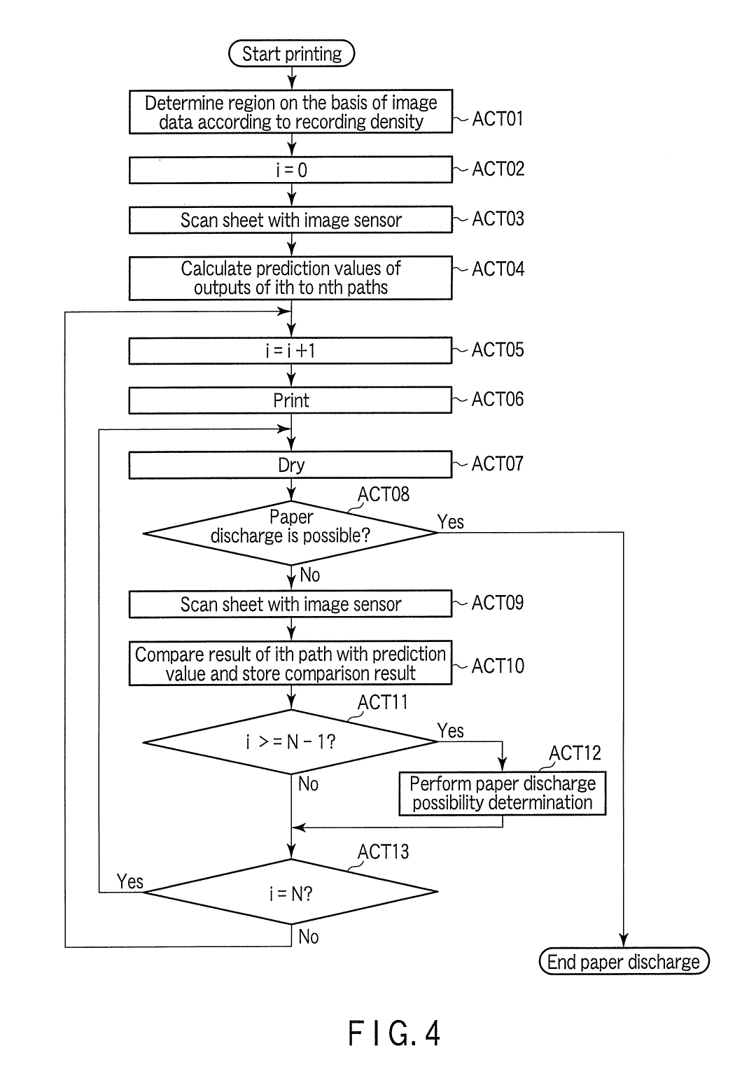

FIG. 4 is an exemplary flowchart for explaining an image forming operation procedure of the inkjet image forming apparatus 1 according to this embodiment.

As explained above, the inkjet image forming apparatus 1 according to this embodiment attracts the sheet P to the drum 11 and repeats the printing process plural times (in multipath) to form an image. In this embodiment, the resolution of the line heads is set to 150 dpi and a 600 dpi output image is finally obtained. The printing process needs to be performed four times in order to obtain a 600 dpi output in the multipath. Therefore, in this embodiment, the drum is rotated four times to generate an output image. In a method of generating an image by rotating the drum four times, after performing printing in one rotation, the line heads are moved in a unit of several pixels to form an image. In other words, an image is formed while shifting the positions of the heads in every rotation. A reference of a start position of the path is a position where the sheet P is stuck. Specifically, a cycle of a sticking start position, the image sensor, the line head unit, the drying unit, and the sticking start position is one path.

In the flowchart of FIG. 4, a method of suppressing ink color transfer to other sheets or ink color transfer to the drum 11 using information obtained from the image sensor 15 is disclosed.

In Act 01, the processor 22a checks, based on image data, a region that is less easily dried. For example, the processor 22a specifies a region where an amount of inks in use is the largest, i.e., a region where recording density is the highest. The processor 22a uses a block including the region for dryness determination after Act 01.

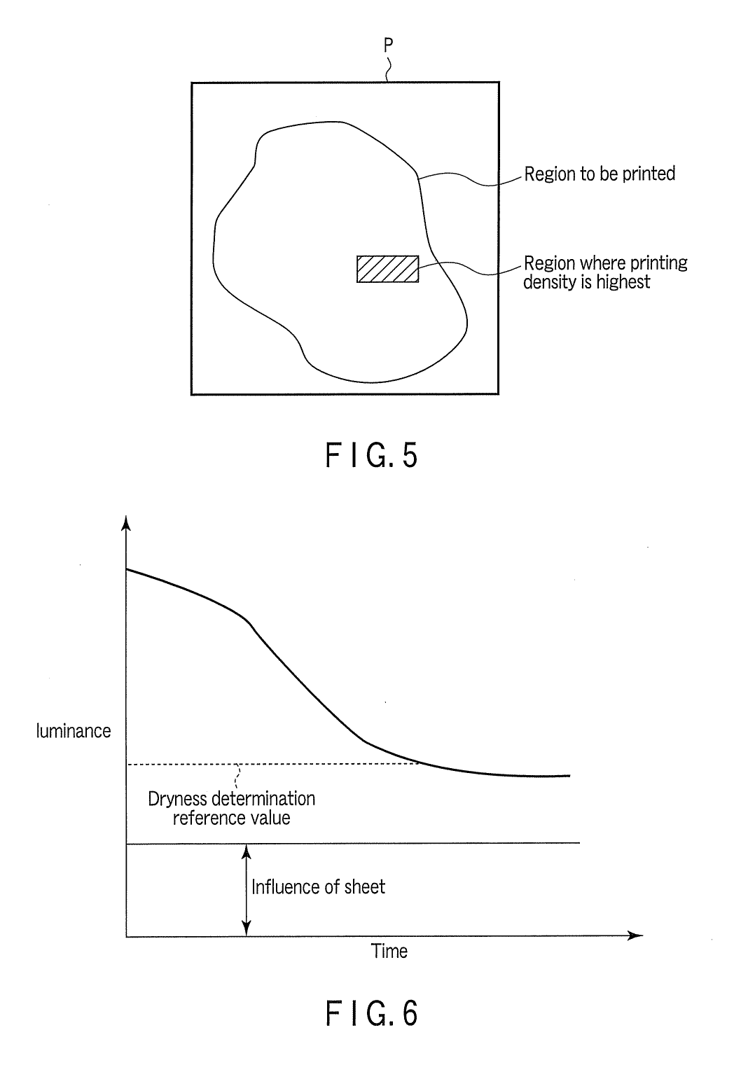

FIG. 5 is an exemplary diagram of a region used for the dryness determination according to this embodiment. In a region printed on the sheet P, a region where a largest amount of inks is used and recording density is the highest is indicated by hatching.

In Act 02, the processor 22a sets a path count i to an initial value (=0). In Act 03, the processor 22a scans a state of the sheet P using the image sensor 15 immediately after the sheet P is attracted. In this state, since the inks are not sprayed on the sheet P, an initial state of the sheet P is detected.

In Act 04, when the number of paths is represented as N, the processor 22a predicts and calculates colors of output results up to an Nth path from data to be printed and initial data of the sheet P. In this example, the processor 22a predicts and calculates colors of output results of a first path, a second path, a third path, and a fourth path. The processor 22a executes calculation of output color values and prediction values by predicting, from image data to be printed and measured characteristics of the inks, color values at points when printing and drying in the respective paths are ended. The prediction is executed for the purpose of determining a dryness degree. It is unnecessary to accurately simulate colors.

FIG. 6 is an exemplary graph for explaining a method of predicting a dried state according to this embodiment. In FIG. 6, temporal transition of the luminance of inks after being sprayed on the sheet P is shown.

Immediately after the inks are sprayed on the sheet P (elapsed time=0), since the inks are not dried, the luminance of the inks are the highest. The luminance of the inks decreases according to elapse of time. When the inks are dried, the luminance of the inks converges on a fixed value. Therefore, when the luminance falls to be equal to or smaller than a dryness determination reference value, it is possible to determine that the inks are dried. This transition of the luminance is different depending on characteristics of the inks. Therefore, the graph of FIG. 6 is obtained by an experiment for each amount of the inks to be sprayed and each characteristic of the inks.

The luminance of the inks to be measured is affected by a paper color of the sheet P. As shown in FIG. 6, the paper color of the sheet P affects the luminance of the inks as a bias value. In Act 03, if an initial paper color obtained in the first path is a paper color not measured in advance, parameters of the prediction value calculation are corrected using a paper color acquired by the image sensor 15.

In Act 05, the processor 22a adds 1 to the path count i. In Act 06, the processor 22a controls the line head unit 12 with image data of an ith path and executes printing. In Act 07, the processor 22a controls the drying unit 13 to dry a printing surface of the sheet P.

In Act 08, the processor 22a checks whether paper discharge is possible. A paper discharge possibility flag EX representing whether paper discharge is possible is provided. An initial value is EX=0. If the paper discharge is possible in processing in the third or subsequent path explained later, the paper discharge possibility flag EX is set as EX=1. If the paper discharge is possible (Yes in Act 08), the processor 22a discharges the sheet P to the outside of the system and ends the processing.

If the paper discharge is impossible (No in Act 08), in Act 09, the image sensor 15 scans a state of the sheet P in the ith path. In this state, since the inks in the ith path are sprayed on the sheet P, the image sensor 15 detects a printing result of the ith path of the sheet P.

In Act 10, the processor 22a compares, concerning a determination target region of the ith path, a measurement value of luminance with a prediction value. If drying is insufficient and moisture remains, since a color space (Gamut) expands, a measured luminance value increases. Therefore, by checking a difference between the luminance measurement value and the prediction value, it is possible to determine whether the drying is performed to a predetermined level. As a result of the determination, a difference value (=luminance measurement value−prediction value) is stored as history information for each determination target region. If the difference value is large, this indicates that the drying is insufficient.

In Act 11, the processor 22a checks whether the present path i is equal to or larger than the immediately preceding path (N−1) of the last path. In the case of i>N=−1 (Yes in Act 11), in Act 12, the processor 22a predicts whether paper discharge is possible in the next (i+1)th path. The processor 22a determines whether paper discharge is possible as explained below.

In the case of the present path i=N−1, the processor 22a determines whether color transfer occurs after a printing process and drying process in the next Nth path. Therefore, the processor 22a calculates a cumulative difference value obtained by totaling difference values in the paths stored as history information. As explained above, if a difference value is large, this indicates that the luminance of an image is larger than predicted, i.e., drying is insufficient. Therefore, if the cumulative difference value is equal to or larger than a predetermined dryness determination reference value TH1, the processor 22a determines that drying is insufficient and sets the paper discharge possibility flag EX as EX=0. If the cumulative difference value is smaller than the predetermined dryness determination reference value TH1, the processor 22a determines that drying is sufficient and sets the paper discharge possibility flag EX as EX=1. This relation is represented by the following formula:

SD=d1+d2+ . . . +dN

if SD>=TH1, drying is insufficient, EX=0

if SD<TH1, drying is sufficient, EX=1

where, di represents a difference value of the ith path, SD represents the cumulative difference value, and TH1 represents dryness determination reference value.

In the case of the present path i>=N, printing is not performed in paths after the present path i. Therefore, the processor 22a determines whether color transfer occurs in the present state. If a difference value dN of the Nth path calculated in Act 10 is equal to or larger than a predetermined dryness determination reference value TH2, the processor 22a determines that drying is insufficient and set the paper discharge possibility flag EX as EX=0. If the difference value dN of the Nth path is smaller than the predetermined dryness determination reference value TH2, the processor 22a determines that drying is sufficient and sets the paper discharge possibility flag EX as EX=1. This relation is represented by the following formula:

if dN>=TH2, drying is insufficient, EX=0

if dN<TH2, drying is sufficient, EX=1.

In the case of i<N−1 (No in Act 11) or if paper discharge possibility is determined in Act 12, in Act 13, the processor 22a checks whether the present path is the Nth path. In other words, the processor 22a checks whether i=N holds.

In the case of i<N (No in Act 13), since printing is not executed to the end, the processor 22a returns to Act 05, adds 1 to the path count i, and executes the processing from Act 06.

In the case of i=N (Yes in Act 13), although the last printing is ended, it is determined in Act 12 that drying is insufficient. Therefore, the processor 22a returns to Act 07, executes only drying without performing printing, and executes the processing from Act 08. In this case, a state of the number of paths i=N is maintained.

The operation of multipath conforming to the processing procedure shown in FIG. 4 explained above is comprehensively explained below. In the following explanation, it is set to form an image in four paths.

In first to third paths, the processor 22a scans and reads printing results in the paths with the image sensor 15. The processor 22a stores differences between measurement values and prediction values of luminance in the paths in a predetermined region as difference values.

In a fourth path, after processing in the immediately preceding path, i.e., drying in the third path, the processor 22a determines whether a sheet may be discharged after printing and drying in the fourth path, which is a specified number of paths. The processor 22a executes the determination by checking whether a sum of difference values of the first to third paths reaches a certain level.

If the sum of the difference values of the first to third paths is smaller than the certain level, the processor 22a discharges the sheet after the printing and the drying in the fourth path, which is the specified number of paths. If the sum of the difference values of the first to third paths is equal to or larger than the certain level, the processor 22a executes a fifth path.

In the fifth and subsequent paths, after processing in the immediately preceding path, i.e., the drying in the fourth path, the processor 22a scans a printing result with the image sensor 15 and checks whether a difference value is smaller than a predetermined value. If the difference value is smaller than the predetermined value, the processor 22a can directly discharge a sheet. If the difference value is equal to or larger than the predetermined value, the processor 22a executes only the drying process and repeatedly executes the processing in the fifth and subsequent paths. An upper limit can be set for the number of times of the repetition. If the number of times of the repetition reaches the upper limit, the processor 22a forcibly discharges a sheet.

During duplex printing, after being once discharged, the sheet P is stuck to the drum 11 from a paper discharge port. If inks are not dried at this point, the drum 11 is stained by the inks and a sheet is stained in the following printing.

According to the first embodiment, it is possible to prevent color transfer to other sheets that occurs if drying is insufficient and color transfer to the drum during the duplex printing. If drying is insufficient, it is possible to take measures by changing a drying process time, i.e., reducing conveying speed. However, in a drum attraction system, to finely control rotating speed of the drum that rotates at high speed, it is necessary to dynamically determine various kinds of processing such as control of attraction timing for a sheet, timing of ink ejection, and timing of paper discharge. Therefore, the processing is complicated and it is difficult to take measures. According to this embodiment, it is possible to sufficiently carry out drying by verifying a dryness degree for each path and, if drying is necessary, changing the number of times of rotation (only in a drying process) without changing the rotating speed. Therefore, it is possible to easily prevent color transfer to other sheets and color transfer to the drum during the duplex printing.

### Second Embodiment

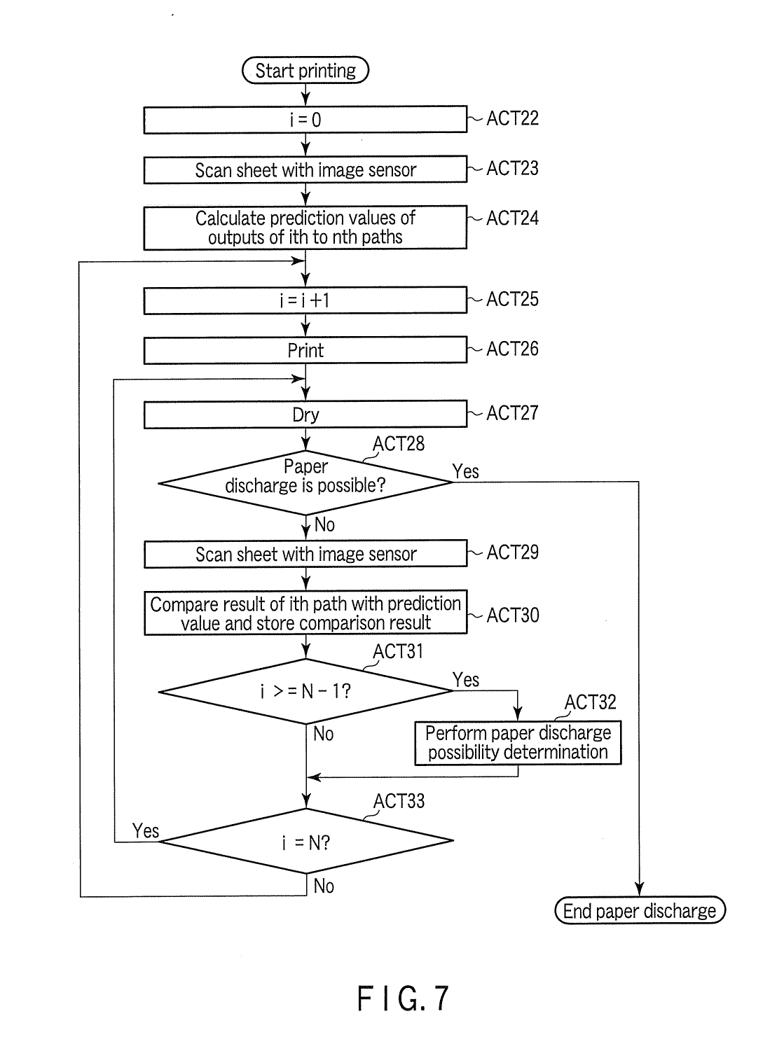

FIG. 7 is an exemplary flowchart for explaining an image forming operation procedure of the inkjet image forming apparatus 1 according to a second embodiment.

A procedure in Act 22 to Act 33 of the flowchart of FIG. 7 is the same as the procedure in Act 02 to Act 13 of the flowchart of FIG. 4. The second embodiment is different from the first embodiment in that the processing in Act 01 of FIG. 4 is not performed. Therefore, components same as those in the first embodiment are denoted by the same reference numerals and signs and detailed explanation of the components is omitted.

In the first embodiment, a place that is least easily dried is calculated from original image data. On the other hand, in the second embodiment, all image data read by the image sensor 15 are targets of the calculation. In the first embodiment, a prediction value to be used is determined from the original image data. However, in the second embodiment, a prediction value set in advance is used.

The processor 22a detects a shift amount while sequentially comparing a measurement value with the prediction value for each block of an image using a line image read by the image sensor 15 and obtains a final determination result of the image at a point when reading of a last line ends. The processor 22a carries out this processing for each path and determines according to the processing procedure explained above whether drying of the image is sufficient or insufficient.

The processor 22a can perform the determination as explained below. For example, the processor 22a can determine that drying is insufficient if at least one insufficiently dried region is present in the image.

The processor 22a can determine that drying is insufficient if a total area of insufficiently dried regions is equal to or larger than a predetermined value.

According to the second embodiment, even if processing for specifying, on image data, a region where drying of inks is considered to be insufficient in advance is not performed, it is possible to perform processing according to an actual printing result.

Therefore, it is possible to simplify processing contents.

### Third Embodiment

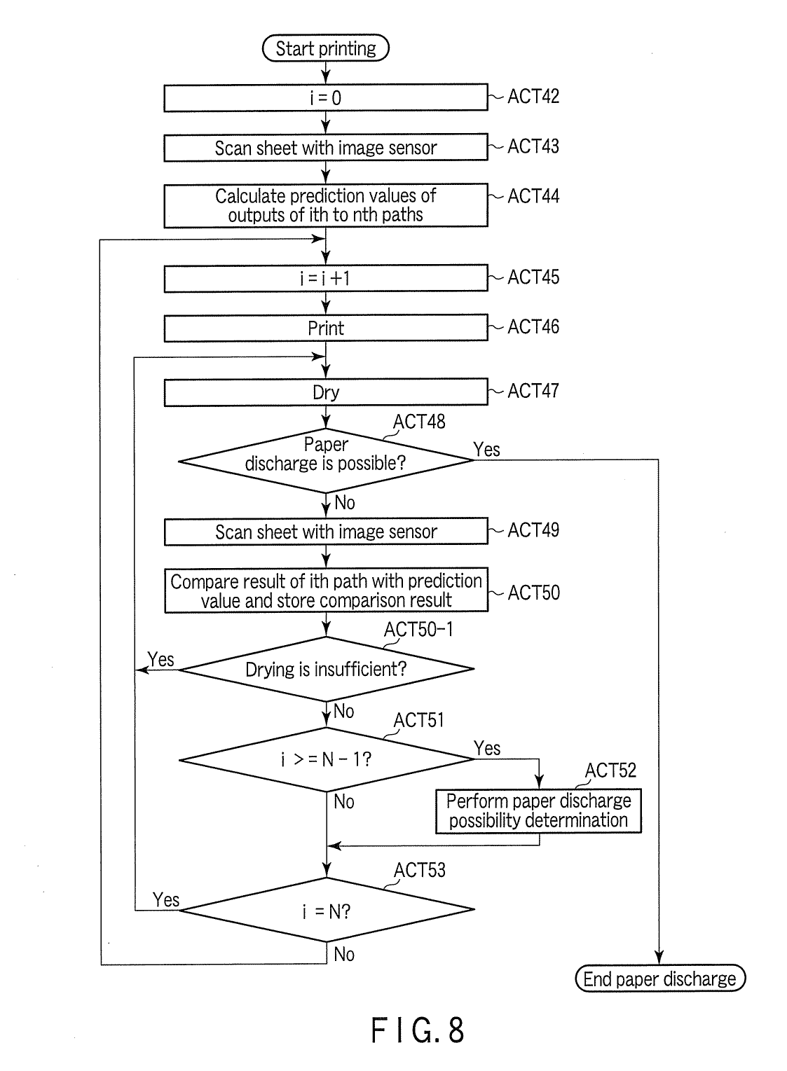

FIG. 8 is an exemplary flowchart for explaining an image forming operation procedure of the inkjet image forming apparatus 1 according to a third embodiment.

A procedure in Act 42 to Act 50 and a procedure in Act 51 to Act 53 of the flowchart of FIG. 8 are respectively the same as the procedure in Act 22 to Act 30 and the procedure in Act 31 to Act 33 of the flowchart of FIG. 7. The third embodiment is different from the second embodiment in that processing in Act 50-1 shown in FIG. 8 is added. Therefore, components same as those in the second embodiment are denoted by the same reference numerals and signs and detailed explanation of the components is omitted.

In the third embodiment, in Act 50-1, the processor 22a compares the luminance of an image obtained by the image sensor 15 in each path with a prediction value and determines whether drying is sufficient. If it is determined that drying is sufficient, the processor 22a carries out only a drying process without performing printing in the next path. After sufficiently performing drying in each path, the processor 22a carries out the next printing path.

According to the third embodiment, since drying can be sufficiently performed in each path, it is possible to prevent diffusion of inks. If the inks are further ejected to an insufficiently dried surface, a sheet moisture tolerance is considered to be exceeded. In such a state, it is more likely that, since a drum is rotating at high speed, the inks not absorbed in a sheet or not evaporated diffuse to the outside of the sheet. Therefore, according to the third embodiment, it is possible to prevent a problem in that the drum is stained by the inks diffusing to the outside of the sheet and other sheets are stained.

In the third embodiment, the processing in Act 50-1 is added to the processing in the second embodiment. However, the processing in Act 50-1 may be added to the processing in the first embodiment.

### Fourth Embodiment

In a fourth embodiment, a glossiness sensor is used instead of the image sensor. Glossiness is high in a state in which inks are not dried as explained above. As the inks are dried, the glossiness falls. Therefore, it is determined whether paper discharge is possible using the glossiness as data for determining a state of drying. It is possible to more directly grasping a dryness state by using the glossiness sensor.

The functions explained in the embodiments may be configured using hardware. The functions may be realized by causing a computer to read a computer program describing the functions using software. The functions may be configured by selecting the software or the hardware as appropriate.

Further, the functions can also be realized by causing the computer to read the computer program stored in a not-shown recording medium. A recording form of the recording medium in the embodiments may be any form as long as the recording medium can record the computer program and can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an endless device which rotates at fixed circumferential speed;
an inkjet head which prints on a recording medium held by the endless device and rotating together with the endless device;
a dryer which dries the recording medium rotating together with the endless device;
a sensor provided to be opposed to the endless device and which detects a surface state of the recording medium printed by the inkjet head; and
a controller configured to determine a dried state of the recording medium on the basis of the surface state detected by the sensor and switch, according to a determination result, control of a next process to drying and paper discharge in a unit of one rotation of the endless device.

2. The apparatus according to claim 1, wherein the controller determines, when the processes are executed a predetermined number of times, the dried state on the basis of comparison results obtained in each of the processes.

3. The apparatus according to claim 1, wherein the controller determines, every time each of the processes is carried out, the dried state on the basis of a comparison result obtained in the process.

4. The apparatus according to claim 1, wherein the controller performs, if it is determined that drying of the recording medium is insufficient, drying of the recording medium without performing printing on the recording medium in the next process.

5. The apparatus according to claim 4, wherein the controller determines, if the endless device rotates a predetermined number of times or more, whether drying of the recording medium is sufficient.

6. The apparatus according to claim 1, wherein the sensor is a line sensor which reads, at a time, a surface state in full width in a main scanning direction of the recording medium.

7. The apparatus according to claim 6, wherein the sensor is a contact image sensor.

8. The apparatus according to claim 6, wherein the sensor detects glossiness.

9. The apparatus according to claim 1, wherein the controller determines the dried state of the recording medium from a value of a surface state predicted in advance obtained from printing data in each of the processes and a surface state of a base of the recording medium detected by the sensor and switches a control method in the next process according to a determination result.

10. The apparatus according to claim 1, wherein the controller determines, from printing data acquired in advance, the dried state targeting a region where recording density is highest.

11. The apparatus according to claim 1, wherein the endless device is a drum.

12. The apparatus according to claim 11, wherein the controller performs, if it is determined that drying of the recording medium is insufficient, drying of the recording medium without performing printing on the recording medium in the next process.

13. The apparatus according to claim 12, wherein the controller determines, if the endless device rotates a predetermined number of times or more, whether drying of the recording medium is sufficient.

14. The apparatus according to claim 11, further comprising a charging roller which electrostatically attracts the recording medium to the drum.

15. The apparatus according to claim 11, wherein a hole is provided on a surface of the drum.

16. The apparatus according to claim 15, further comprising a fan which attracts the recording medium to the drum.

17. An image forming method comprising:
printing, with inkjet, on a recording medium, which is held by an endless device which rotates at fixed circumferential speed and rotates together with the endless device, and drying the recording medium rotating together with the endless device;
detecting, with a sensor provided at a post stage of the dryer, a surface state of the recording medium printed by the inkjet head;
determining a dried state of the recording medium on the basis of a value of the surface state of the recording medium; and
switching, according to a determination result, control of a next process to drying and paper discharge in a unit of one rotation of the endless device.

18. The method according to claim 17, wherein the determining the dried state includes determining, when the processes are executed a predetermined number of times, the dried state on the basis of a comparison result obtained in each of the processes.

19. The method according to claim 17, wherein the determining the dried state includes determining, every time each of the processes is carried out, the dried state on the basis of a comparison result obtained in the process.
